(19) United States
(12) Patent Application Publication
(10) Pub. No.: US 2026/0194196 A1
(43) Pub. Date: Jul. 9, 2026

(54) Retractable Illuminated Window Decorations Device

(71) Applicants: Ben Miller, Bessemer, AL (US); Deandre Miller, Bessemer, AL (US)

(72) Inventors: Ben Miller, Bessemer, AL (US); Deandre Miller, Bessemer, AL (US)

(21) Appl. No.: 19/169,079

(22) Filed: Apr. 3, 2025

Related U.S. Application Data
(60) Provisional application No. 63/743,439, filed on Jan. 9, 2025.

(51) Int. Cl. F21S 9/02; F21V 19/00; F21V 19/02; F21V 23/04; F21V 23/06; F21Y 105/12; F21Y 113/13; F21Y 115/10

(52) U.S. Cl. CPC F21S 9/02; F21V 19/0015; F21V 19/02; F21V 23/0471; F21V 23/06; F21Y 2105/12; F21Y 2113/13; F21Y 2115/10

(57) ABSTRACT

A retractable illuminated window decoration device is provided. The device is designed for convenient and visually appealing decoration of windows and other surfaces for various occasions. The device comprises a body made from durable, semi-transparent, or opaque materials embedded with LED lights arranged in customizable patterns. The lights offer multiple brightness levels, colors, and effects, controlled via buttons, motion sensors, or timers. A spring-tension rod allows for easy installation to windows or other surfaces, with fasteners ensuring secure attachment. The body extends via a handle and retracts into the rod for compact storage when not in use. Power is supplied by disposable or rechargeable batteries or a power cord. In different embodiments, the LED lights may be repositionable, and/or the body is removably attached to the spring-tension rod for replaceability.

### CROSS-REFERENCE TO RELATED APPLICATION

The present application claims priority to, and the benefit of, U.S. Provisional Application No. 63/743,439, which was filed on Jan. 9, 2025, and is incorporated herein by reference in its entirety.

### FIELD OF THE INVENTION

The present invention relates generally to the field of decorations. More specifically, the present invention relates to a device that provides a convenient and visually appealing way to decorate windows and other surfaces using a body embedded with customizable LED lights, wherein the body is attached to a spring-tension rod for easy installation and storage. Accordingly, the present disclosure makes specific reference thereto. Nonetheless, it is to be appreciated that aspects of the present invention are also equally applicable to other like applications, devices, and methods of manufacture.

### BACKGROUND

Placing window decorations for holidays, birthdays, graduations, anniversaries, and other special events is a common tradition that enhances the festive atmosphere of a home or venue. However, the process of setting up and removing decorations for each occasion can be time-consuming and inconvenient. Many decorations, such as string lights, banners, and decals, require effort to install and secure, often involving adhesives, staples, or extension cords. This can lead to difficulties in achieving a secure and aesthetically pleasing arrangement, especially when dealing with outdoor elements or large window surfaces. Additionally, frequent installation and removal of decorations may cause damage to windows, walls, or other surfaces. Users may also struggle with proper storage of decorations between events, leading to clutter and potential damage to delicate items. The need for a more efficient and reusable decoration solution is particularly relevant for individuals with limited time, mobility constraints, or a desire to simplify seasonal decorating. A system that allows for quick and effortless decoration changes without requiring extensive setup would significantly improve convenience and user experience.

Therefore, there exists a long-felt need in the art for a retractable illuminated window decoration device that allows users to efficiently decorate their windows with illuminated displays for various holidays and special events. There also exists a long-felt need in the art for a retractable illuminated window decoration device that eliminates the need for time-consuming installation processes involving adhesives, staples, or extension cords. Moreover, there exists a long-felt need in the art for a retractable illuminated window decoration device that enables users to easily switch between different decorative designs without requiring the purchase or storage of multiple individual decorations.

The subject matter disclosed and claimed herein, in one embodiment thereof, comprises a retractable illuminated window decoration device. The device is designed for convenient and visually appealing decoration of windows and other surfaces for various occasions. The device comprises a body made from durable, semi-transparent, or opaque materials embedded with LED lights arranged in customizable patterns. The lights offer multiple brightness levels, colors, and effects, controlled via buttons, motion sensors, or timers. A spring-tension rod allows for easy installation to windows or other surfaces, with fasteners ensuring secure attachment. The body extends via a handle and retracts into the rod for compact storage when not in use. Power is supplied by disposable or rechargeable batteries or a power cord. In different embodiments, the LED lights may be repositionable, and/or the body is removably attached to the spring-tension rod for replaceability.

In this manner, the retractable illuminated window decoration device of the present invention accomplishes all the foregoing objectives and provides an easy-to-use, interchangeable decoration device that enhances the visual appeal of a window while minimizing setup time and effort. More specifically, the embedded LED lights are arranged in festive patterns, ensuring an illuminated display suitable for various occasions. The inclusion of a spring-tension rod allows for secure mounting without the need for adhesives or permanent fixtures, reducing potential damage to window surfaces. The retractable design ensures that users can conveniently extend and retract the decoration as needed, preserving its appearance and functionality. Additionally, the ability to swap out different canvases with varied light patterns offers a customizable and space-saving solution for seasonal and event-based decorating. As a result, the device provides an efficient and adaptable approach to window decoration, catering to a wide range of user preferences and requirements.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retractable illuminated window decoration device. The device provides an easy-to-install, interchangeable, and retractable decoration for windows and similar surfaces, enhancing festive atmospheres for various occasions while minimizing effort.

The device is comprised of a body with at least one embedded LED light is arranged in festive patterns or customizable designs. The lights may be repositionable and support various colors, brightness levels, and lighting effects, including steady illumination, twinkling, pulsing, fading, cascading, or randomized flashing. The lights may be controlled via a button, motion sensor, or timer, with brightness adjustments based on ambient lighting.

The body is attached to a spring-tension rod, which may feature a locking mechanism to secure different extended lengths. The rod is mountable using fasteners such as brackets, suction cups, adhesive strips, or hook-and-loop systems. A handle allows the user to extend the body for display, and the built-in tension mechanism enables retraction for compact storage.

The device is also comprised of a battery, which may be disposable or rechargeable via a charging port. In some embodiments, the device may include a power cord, which may be detachable or integrated, with an inline power switch for convenience.

A method of using the device involves mounting the rod, extending the body, activating the lights via a button, motion sensor, or timer, adjusting brightness and effects, and retracting the body for storage. The body may be interchangeable with others featuring different light arrangements, or the lights may be repositioned for varied designs.

Accordingly, the retractable illuminated window decoration device of the present invention is particularly advantageous as it provides an easy-to-use, interchangeable decoration device that enhances the visual appeal of a window while minimizing setup time and effort. More specifically, the embedded LED lights are arranged in festive patterns, ensuring an illuminated display suitable for various occasions. The inclusion of a spring-tension rod allows for secure mounting without the need for adhesives or permanent fixtures, reducing potential damage to window surfaces. The retractable design ensures that users can conveniently extend and retract the decoration as needed, preserving its appearance and functionality. Additionally, the ability to swap out different canvases with varied light patterns offers a customizable and space-saving solution for seasonal and event-based decorating. As a result, the device provides an efficient and adaptable approach to window decoration, catering to a wide range of user preferences and requirements.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of a body of one potential embodiment of a retractable illuminated window decoration device of the present invention in accordance with the disclosed architecture;

FIG. 2 illustrates a front view of one potential embodiment of a retractable illuminated window decoration device of the present invention in accordance with the disclosed architecture; and

FIG. 3 illustrates a flowchart of a method of using one potential embodiment of a retractable illuminated window decoration device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a retractable illuminated window decoration device that allows users to efficiently decorate their windows with illuminated displays for various holidays and special events. There also exists a long-felt need in the art for a retractable illuminated window decoration device that eliminates the need for time-consuming installation processes involving adhesives, staples, or extension cords. Moreover, there exists a long-felt need in the art for a retractable illuminated window decoration device that enables users to easily switch between different decorative designs without requiring the purchase or storage of multiple individual decorations.

The present invention, in one exemplary embodiment, is comprised of a retractable illuminated window decoration device. The device offers a simple, interchangeable, and retractable decoration for windows and similar surfaces, creating a festive atmosphere for various occasions while reducing effort. The device is comprised of a body with at least one embedded LED light arranged in festive patterns or customizable designs. The lights may be repositionable and support multiple colors, brightness levels, and lighting effects, including steady illumination, twinkling, pulsing, fading, cascading, or randomized flashing. Control options include a button, motion sensor, or timer, with adjustable brightness based on ambient lighting.

The body is attached to a spring-tension rod, which may include a locking mechanism to secure different extended lengths. The rod can be mounted using fasteners such as brackets, suction cups, adhesive strips, or hook-and-loop systems. A handle allows for easy extension of the body, while the built-in tension mechanism enables smooth retraction for compact storage.

The device also includes a battery, which may be disposable or rechargeable via a charging port. In some embodiments, a power cord may be provided, either detachable or integrated, with an inline power switch for convenience.

A method of using the device involves mounting the rod, extending the body, activating the lights via a button, motion sensor, or timer, adjusting brightness and effects, and retracting the body for storage. The body may be interchangeable with others featuring different light patterns, or the lights may be repositioned to create varied designs.

As a result, the retractable illuminated window decoration device offers a user-friendly, interchangeable decoration that enhances window displays while minimizing setup time and effort. The embedded LED lights provide an illuminated display suitable for various occasions. The inclusion of a spring-tension rod allows secure mounting without adhesives or permanent fixtures, reducing potential surface damage. The retractable design ensures easy extension and storage, maintaining the decoration's appearance and functionality. Additionally, the option to swap different canvases with varied light patterns offers a customizable and space-efficient solution for seasonal and event-based decorating, catering to diverse user preferences.

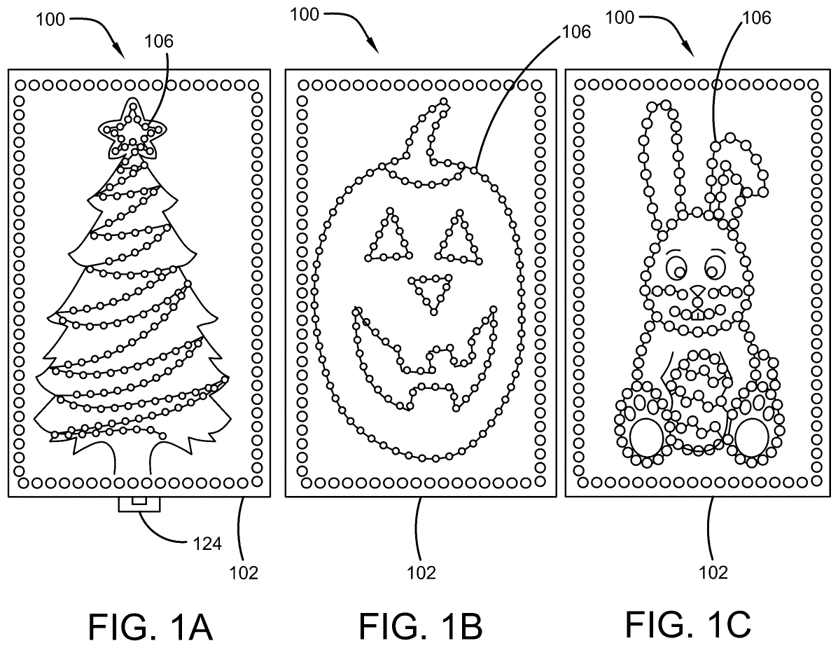

Referring initially to the drawings, FIG. 1 illustrates a front view of a body of one potential embodiment of a retractable illuminated window decoration device 100 of the present invention in accordance with the disclosed architecture. The retractable illuminated window decoration device 100 is designed to provide a simple, convenient, and visually appealing way to decorate windows and other surfaces for holidays, birthdays, graduations, anniversaries, and other special events by offering an easy-to-install, interchangeable, and retractable window decoration that enhances the festive atmosphere of any space while saving time and effort.

The device 100 is comprised of a body 102, as seen in FIG. 1. The body 102 is made from a canvas or canvas-like material such as, but not limited to, polyester, vinyl-coated material, or translucent mesh, ensuring longevity and resistance to wear. The material may be semi-transparent or opaque, depending on the desired lighting effect. A transparent version allows users to maintain visibility through the window while still displaying the illuminated design. The semi-transparent version diffuses the light emitted by the LED lights 106, creating a softer glow, while the opaque version enhances the contrast of the illuminated design. The body 102 may also be treated with UV-resistant coating 103 to prevent fading due to prolonged sun exposure.

The edges of the body 102 are reinforced with stitched or heat-sealed hems 104 to prevent fraying and maintain structural integrity. In one embodiment, the hems 104 are reinforced flexible polymer or rubberized hems to enhance durability and provide additional resistance against tearing. In another embodiment, the hems 104 may be weighted hems to ensure that the body 102 remains taut and does not curl or wrinkle when extended.

The body 102 is comprised of at least one embedded LED light 106. The lights 106 may be arranged in festive patterns to resemble festive iconography associated with various holidays and special occasions, including but not limited to Christmas, Halloween, Easter, national celebrations, birthdays, graduations, anniversaries, Valentine's Day, New Year's Eve, weddings, baby showers, and other seasonal or personal events. Additionally, the lights 106 may be arranged in any image, number, letter, scene, or other decorative formation, allowing for a wide range of designs that enhance the visual appeal and thematic relevance of the display. The LED lights 106 may be positioned in uniform rows, clusters, or custom configurations, depending on the specific design requirements. In one embodiment, the lights 106 are repositionable about the body 102 to allow different arrangements to be created.

The LED lights 106 may illuminate at least one color and at least one brightness level, as controlled by at least one button 107. In one embodiment, the brightness level is adjustable, allowing users to dim or brighten the display based on ambient lighting conditions. The lights 106 may have different lighting effects, such as, but not limited to, steady illumination, twinkling, pulsing, fading transitions, cascading sequences, or randomized flashing. The lighting effects may be controlled manually or automatically through pre-programmed sequences.

In one embodiment, the lights 106 are motion-activated lights that automatically turn on when the body 102 is unrolled or when movement is detected nearby. The motion sensor 109 may be positioned at the top of the body 102 near the rod 120 or integrated along the length of the body 102 to detect motion from various angles. In a further embodiment, the device 100 may be comprised of a button 107 for manual light 106 activation. The button 107 may be a physical push button, a capacitive touch button, or a toggle switch. In an additional embodiment, the lights 106 may be activated by a timer 110. The timer 110 may allow users to set specific activation durations such as, but not limited to, 15 minutes, 30 minutes, 1 hour, or continuous operation.

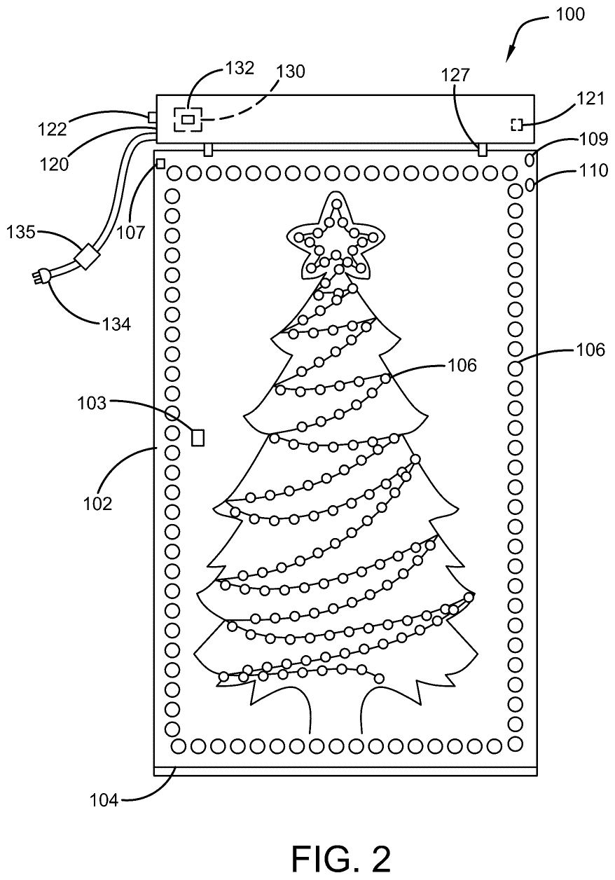

The body 102 is attached to a spring-tension rod 120, as seen in FIG. 2. In one embodiment, the body 102 is removably attached to the rod 120 via a fastener 127 such as a clip, a clamp, etc., that allows different bodies 102 with different light arrangements to be used with a singular rod 120. The rod 120 may be comprised of at least one fastener 122 such as, but not limited to, a mounting bracket, a suction cup, an adhesive strip, or a hook-and-loop fastening system. The fastener 122 allows the rod 120 to be securely positioned on, to, or over a window, door, or similar surface.

Once the device 100 is secured, the user can pull down the body 102 to cover the designated area via at least one handle 124, displaying the illuminated design of the lights 106. When the decoration is no longer needed, the user can roll up the body 102 using the built-in tension mechanism of the rod 120, keeping the display neatly stored until its next use. In one embodiment, the rod 120 includes a locking mechanism 121 that allows the body 102 to be secured at different extended lengths.

The lights 106 may be powered by at least one battery 130. The battery 130 may be a disposable battery, such as an alkaline or lithium battery, or in another embodiment, the battery 130 is rechargeable. In the rechargeable embodiment, the battery 130 may be powered via at least one charging port 132, such as, but not limited to, a USB-C port, a micro-USB port, or a proprietary charging connector. In a further embodiment, the device 100 may be powered via at least one power cord 134. The power cord 134 may be detachable or permanently affixed, depending on the embodiment. In one embodiment, the power cord 134 is comprised of an inline power switch 135 for convenient on/off control.

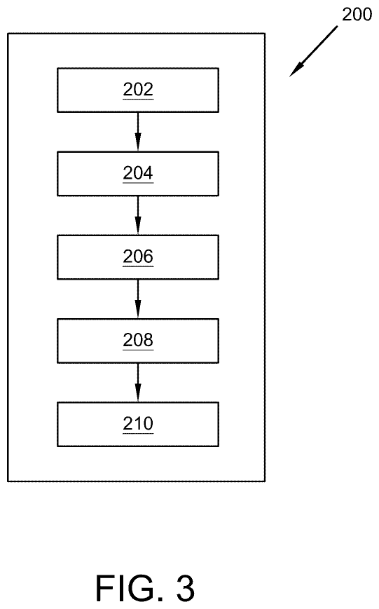

The present invention is also comprised of a method of using 200 the device 100, as seen in FIG. 3. First, a device 100 is provided, comprised of a body 102 having at least one embedded LED light 106, a spring-tension rod 120, at least one fastener 122, at least one handle 124, at least one button 107, and at least one battery 130 [Step 202]. Then, the fastener 122 is used to mount the rod 120 onto a window, door, or similar surface to secure the device 100 in place [Step 204]. Next, the body 102 is pulled downward using the handle 124 to extend the decoration and reveal the illuminated design of the LED lights 106 [Step 206]. Then, the LED lights 106 are activated using at least one activation method, including, but not limited to, a button 107, a motion sensor 109, or a timer 110, wherein the lighting effect and brightness may be adjusted as desired [Step 208]. Finally, when the decoration is no longer needed, the body 102 is retracted by rolling it back into the rod 120 using the built-in tension mechanism, and the device 100 remains stored in a compact form until its next use [Step 210]. Optionally, a user can detach the body 102 from the rod 120 and reattach a second body 102 with a different light 106 pattern to the rod 120 or reposition the lights 106 on the body 102 to achieve a different appearance.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “retractable illuminated window decoration device” and “device” are interchangeable and refer to the retractable illuminated window decoration device 100 of the present invention.

Notwithstanding the foregoing, the retractable illuminated window decoration device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the retractable illuminated window decoration device 100 as shown in the FIGS. are for illustrative purposes only, and that many other sizes and shapes of the retractable illuminated window decoration device 100 are well within the scope of the present disclosure. Although the dimensions of the retractable illuminated window decoration device 100 are important design parameters for user convenience, the retractable illuminated window decoration device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A retractable illuminated window decoration device comprising:
a spring-tension rod;
a body attached to the spring-tension rod via a fastener;
an LED light arranged on the body; and
a power source configured to supply power to the LED light;
wherein an edge of the body is a heat-sealed flexible polymer hem; and
further wherein the fastener is a suction cup.

2. The retractable illuminated window decoration device of claim 1, wherein the body is comprised of a UV-resistant coating.

3. (canceled)

4. (canceled)

5. (canceled)

6. The retractable illuminated window decoration device of claim 1, wherein a brightness of the LED light is adjustable.

7. The retractable illuminated window decoration device of claim 1, wherein a color of the LED light is adjustable.

8. The retractable illuminated window decoration device of claim 1 further comprised of a timer that controls an activation duration of the LED light.

9. The retractable illuminated window decoration device of claim 1 further comprised of a button that controls an activation of the LED light.

10. A retractable illuminated window decoration device comprising:
a spring-tension rod;
a body removably attached to the spring-tension rod via a fastener, the body comprised of a handle;
an LED light arranged on the body; and
a power source configured to supply power to the LED light; and
a motion sensor integrated into a length of the body for activating the LED light, wherein the fastener is a hook-and-loop fastener.

11. (canceled)

12. The retractable illuminated window decoration device of claim 10, wherein the LED light is repositionable on the body.

13. The retractable illuminated window decoration device of claim 10 further comprised of a button that controls an activation of the LED light.

14. (canceled)

15. The retractable illuminated window decoration device of claim 10, wherein the LED light has a steady illumination, a twinkling, a pulsing, a fading transition, a cascading sequence, or a randomized flashing lighting effect.

16. (canceled)

17. (canceled)

18. The retractable illuminated window decoration device of claim 10, wherein the spring-tension rod is comprised of a locking mechanism.

19. The retractable illuminated window decoration device of claim 10 further comprised of a battery comprised of a charging port.

20. A method of using a retractable illuminated window decoration device, the method comprising the following steps:
providing a retractable illuminated window decoration device comprised of a body comprised of an LED light, a spring-tension rod, a fastener, a handle, a button, and a power source;
securing the rod to a surface using the fastener;
pulling downward on the handle to extend the body from around the spring-tension rod;
activating the LED light; and
retracting the body by rolling the body back into the spring-tension rod;
wherein an edge of the body is a heat-sealed flexible rubberized hem; and
further wherein the fastener is an adhesive strip fastener.
